(19) United States
(12) Patent Application Publication
(10) Pub. No.: US 2018/0272965 A1
(43) Pub. Date: Sep. 27, 2018

(54) ENHANCED VEHICLE SYSTEM NOTIFICATION

(71) Applicant: Ford Global Technologies, LLC, Dearborn, MI (US)

(72) Inventors: YIFAN CHEN, Ann Arbor, MI (US); BASAVARAJ TONSHAL, Northville, MI (US); KWAKU O. PRAKAH-ASANTE, Commerce Twp., MI (US); PADMA AISWARYA KOLISETTY, Chennai, Tamil Nadu (IN); HSIN-HSIANG YANG, Ann Arbor, MI (US)

(73) Assignee: Ford Global Technologies, LLC, Dearborn, MI (US)

(21) Appl. No.: 15/761,477

(22) PCT Filed: Oct. 27, 2015
(86) PCT No.: PCT/US15/57489

§ 371 Date: Mar. 20, 2018

(51) Int. Cl. B60R 16/023; H04L 29/08; G06F 3/0484

(52) U.S. Cl. CPC B60R 16/0232; H04L 67/12; G08B 6/00; G06F 3/04847; H04L 67/322

(57) ABSTRACT

A plurality of messages received within a predetermined period of time are prioritized. Each of the messages include data relating to one of a plurality of vehicle systems. An output is actuated in a wearable device according to a highest priority message.

### CROSS-REFERENCE TO RELATED APPLICATIONS

This application is a national stage of, and claims priority to, Patent Cooperation Treaty Application No. PCT/US2015/057489, filed on Oct. 27, 2015, which application is hereby incorporated herein by reference in its entirety.

### BACKGROUND

Vehicle computers can generate messages for occupants, e.g., regarding faults, dangers, and/or other issues relating to vehicle operation and/or systems. However, a vehicle computer may generate messages in a short period of time, rendering the occupant unable to consider more than one, or fewer than all, of the messages.

### BRIEF DESCRIPTION OF THE DRAWINGS

FIG. 1 is a block diagram of an example system including a wearable device providing output indicating a message for a vehicle occupant and information about a vehicle system.

FIG. 2 is an example process for providing the message to the vehicle occupant on a wearable device and providing further information about the message in the vehicle.

### DETAILED DESCRIPTION

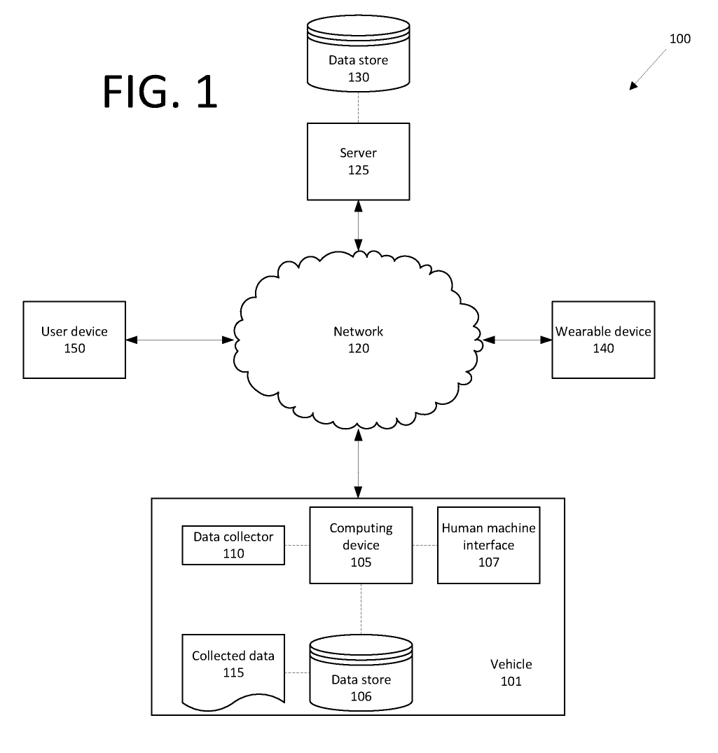

FIG. 1 illustrates a system 100 including a wearable device 140 communicatively coupled to a vehicle 101 computing device 105. The computing device 105 is programmed to receive collected data 115 from one or more data collectors 110, e.g., vehicle 101 sensors, concerning various metrics related to the vehicle 101. For example, the metrics may include a velocity of the vehicle 101, vehicle 101 acceleration and/or deceleration, data related to vehicle 101 path or steering including lateral acceleration, curvature of the road, biometric data related to a vehicle 101 operator, e.g., heart rate, respiration, pupil dilation, body temperature, state of consciousness, etc. Further examples of such metrics may include measurements of vehicle systems and/or components (e.g. a steering system, a powertrain system, a brake system, internal sensing, external sensing, etc.). The computing device 105 may be programmed to collect data 115 from the vehicle 101 in which it is installed, sometimes referred to as a host vehicle 101, and/or may be programmed to collect data 115 about a second vehicle 101, e.g., a target vehicle. The computing device 105 may be further programmed to receive messages from various vehicle systems, e.g., diagnostic messages, a message of a phone call, text message, or email, a message on the current entertainment, including an entertainment title, playback time, radio station, etc., including from a human machine interface 107.

The computing device 105 is generally programmed for communications on a controller area network (CAN) bus or the like. The computing device 105 may also have a connection to an onboard diagnostics connector (OBD-II). Via the CAN bus, OBD-II, and/or other wired or wireless mechanisms, the computing device 105 may transmit messages to various devices in a vehicle and/or receive messages from the various devices, e.g., controllers, actuators, sensors, etc., including data collectors 110. Alternatively or additionally, in cases where the computing device 105 actually comprises multiple devices, the CAN bus or the like may be used for communications between devices represented as the computing device 105 in this disclosure. In addition, the computing device 105 may be programmed for communicating with the network 120, which, as described below, may include various wired and/or wireless networking technologies, e.g., cellular, Bluetooth, wired and/or wireless packet networks, etc.

The computing device 105 may be programmed to receive a plurality of messages from vehicle 101 systems and prioritize the messages based on a classification. The classification may prioritize messages that require more immediate attention, e.g., vehicle 101 diagnostics. Further, the computing device 105 may include or be connected to an output mechanism to indicate such a message, e.g., sounds and/or visual indicators provided via the vehicle 101 human machine interface (HMI) 107.

The data store 106 may be of any known type, e.g., hard disk drives, solid-state drives, servers, or any volatile or non-volatile media. The data store 106 may store the collected data 115 sent from the data collectors 110.

The vehicle 101 may include a human machine interface (HMI) 107. The HMI 107 may allow an operator of the vehicle 101 to interface with the computing device 105, with electronic control units, etc. The HMI 107 may include any one of a variety of computing devices including a processor and a memory, as well as communications capabilities. The HMI 107 may include capabilities for wireless communications using IEEE 802.11, Bluetooth, and/or cellular communications protocols, etc. The HMI 107 may further include interactive voice response (IVR) and/or a graphical user interface (GUI), including e.g., a touchscreen or the like, etc. The HMI 107 may communicate with the network 120 that extends outside of the vehicle 101 and may communicate directly with the computing device 105, e.g., using Bluetooth, etc.

Data collectors 110 may include a variety of devices. For example, various controllers in a vehicle may operate as data collectors 110 to provide data 115 via the CAN bus, e.g., data 115 relating to vehicle speed, acceleration, system and/or component functionality, etc., of any number of vehicles 101, including the host vehicle and/or the target vehicle. Further, sensors or the like, global positioning system (GPS) equipment, etc., could be included in a vehicle and configured as data collectors 110 to provide data directly to the computer 105, e.g., via a wired or wireless connection. Sensor data collectors 110 could include mechanisms such as RADAR, LIDAR, sonar, etc. sensors that could be deployed to measure a distance between the vehicle 101 and other vehicles or objects. Yet other data collectors 110 could include cameras, breathalyzers, motion detectors, etc., i.e., data collectors 110 to provide data 115 for evaluating a condition or state of a vehicle 101 operator.

Collected data 115 may include a variety of data collected in a vehicle 101. Examples of collected data 115 are provided above, and moreover, data 115 is generally collected using one or more data collectors 110, and may additionally include data calculated therefrom in the computing device 105, and/or at the server 125. In general, collected data 115 may include any data that may be gathered by the data collectors 110 and/or computed from such data. The collected data 115 may be used by the computing device 105 to generate the messages for vehicle 101 systems that require occupant attention.

The system 100 may further include a network 120 connected to a server 125 and a data store 130. The computer 105 may further be programmed to communicate with one or more remote sites such as the server 125, via a network 120, such remote site possibly including a data store 130. The network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be programmed to determine an appropriate action for one or more vehicles 101, and to provide direction to the computer 105 to proceed accordingly. The server 125 may be one or more computer servers, each generally including at least one processor and at least one memory, the memory storing instructions executable by the processor, including instructions for carrying out various steps and processes described herein. The server 125 may include or be communicatively coupled to a data store 130 for storing collected data 115, records relating to potential incidents generated as described herein, lane departure profiles, etc. Further, the server 125 may store information related to particular vehicle 101 and additionally one or more other vehicles 101 operating in a geographic area, traffic conditions, weather conditions, etc., within a geographic area, with respect to a particular road, city, etc. The server 125 could be programmed to provide alerts and/or messages to a particular vehicle 101 and/or other vehicles 101.

A wearable device 140 may be any one of a variety of computing devices including a processor and a memory, as well as communication capabilities that is programmed to be worn on a driver's body. For example, the wearable device 140 may be a watch, a smart watch, a vibrating apparatus, etc. that includes capabilities for wireless communications using IEEE 802.11, Bluetooth, and/or cellular communications protocols. Further, the wearable device 140 may use such communications capabilities to communicate via the network 120 and also directly with a vehicle computer 105 and/or a user device 150, e.g., using Bluetooth. The wearable device 140 may include an action mechanism, e.g. a button, a touchscreen prompt, a switch, etc., to allow the vehicle 101 occupant to indicate receipt of a message sent to the wearable device and/or to send an instruction to the computing device 105. The wearable device 140 may further include a data collector to, e.g., collect biometric data related to a vehicle 101 operator, e.g., heart rate, respiration, pupil dilation, body temperature, state of consciousness, etc.

The system 100 may include, in addition to the wearable device 140, a user device 150. The user device 150 may be any one of a variety of computing devices including a processor and a memory, e.g., a smartphone, a tablet, a personal digital assistant, etc. the user device 150 may use the network 120 to communicate with the vehicle computer 105 and the wearable device 140 to, e.g., actuate an output mechanism in the wearable device 140.

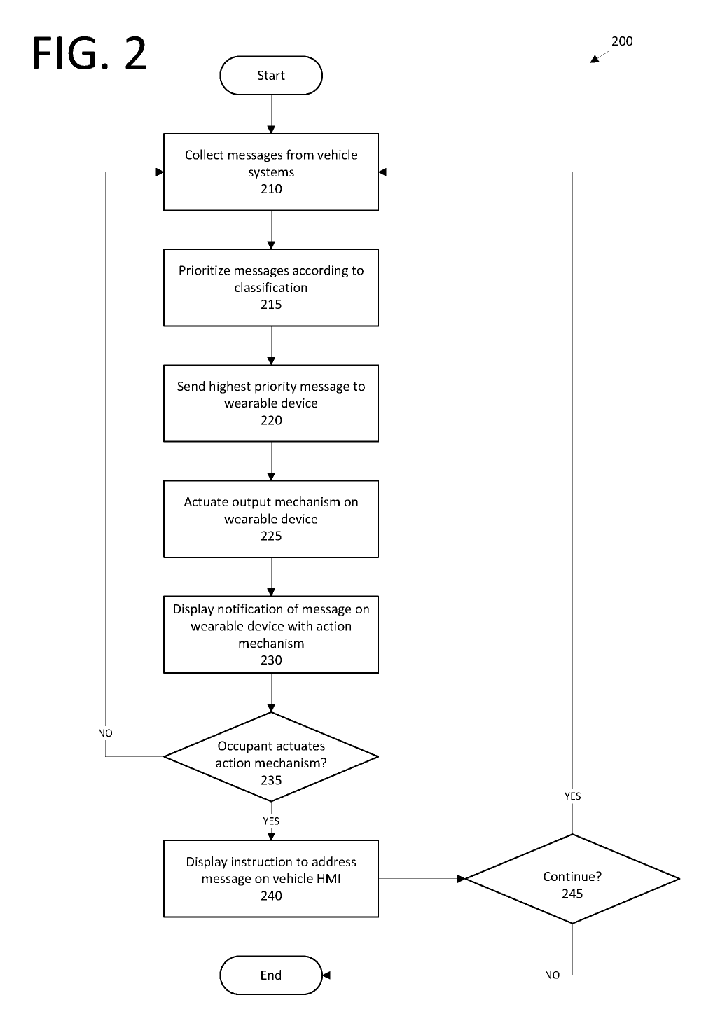

FIG. 2 illustrates a process 200 for prioritizing vehicle 101 system messages and providing information about on the messages to the vehicle 101 occupant. The process starts in a block 210, where the computing device 105 identifies a plurality of messages to be provided to the user device 150 and/or a vehicle human machine interface (HMI) 107 within a predetermined period of time, e.g., five seconds, ten seconds, etc. For example, messages may be based on data 115 from one or more vehicle 101 systems, e.g., an engine, a powertrain, tire pressure sensors, gas tank sensors, etc., and/or from messages or data from the server 125. The computing device 105 may send the messages to the server 125 to catalog messages generated by the vehicle 101 systems. The computing device 105 may designate some of the messages as user-facing messages, i.e., messages that may be sent to a vehicle 101 occupant for interaction with the occupant. Such user-facing messages include, e.g., vehicle 101 system information, entertainment information, safety information, diagnostic or malfunction information, etc. Furthermore, the vehicle 101 infotainment channel of the vehicle 101 communications bus may define messages as user-facing.

Next, in a block 215, the user device 150 prioritizes the plurality of messages identified in the block 210 according to a prioritization. For example, the computing device 105 may be programmed with a preset prioritization determined, e.g., as is known, by, e.g., a manufacturer, and the user device 150 may receive the prioritization from the computing device 105. The prioritization ranks each message, with messages identified as messages that should be addressed immediately ranking higher than messages providing information to which a delayed response is acceptable. For example, a message from a vehicle 101 engine indicating an overheating engine, which may require immediate attention, could be ranked higher than a message from a phone call coming into the user device 150. Similarly, the phone call may have a higher rank than a message from a vehicle 101 entertainment system indicating that a particular song is about to be played. In general, messages related to diagnostic systems (e.g. overheating engine, low gasoline, low tire pressure, etc.) rank higher than communicative messages (e.g. phone calls, text messages, etc.), both of which rank higher than entertainment messages (e.g. a preferred song, a show on a particular radio station, etc.). The user device 150 may selectively prioritize messages marked as user-facing messages by the computing device 105. Alternatively, the computing device 105 may prioritize the plurality of messages.

Next, in a block 220, the user device 150 selects the message with the highest priority and sends the message to the wearable device 140. For example, the user device 150 may search the messages for the message that has the highest priority that is also a user-facing message and send the user-facing message with the highest priority to the wearable device 140. Alternatively, the computing device 105 may select the message with the highest priority and send the message to the wearable device 140.

Next, in a block 225, the user device 150 provides an instruction to the wearable device 140 to actuate one or more output mechanisms. The output mechanisms may include haptic output, e.g. a vibration, audio output, and/or visual output, e.g. flashing lights, flashing colors, etc. The instruction may direct the wearable device 140 to actuate different output mechanisms depending on the prioritization of the message. For example, a high priority message may include actuation of both haptic and audio mechanisms, while a low priority message may use only one of a haptic and an audio mechanism. Alternatively, the computing device 105 may provide the instruction to the wearable device 140 to actuate the output mechanisms.

Next, in a block 230, the user device 150 provides an instruction to the wearable device 140 to display, e.g., show on an HMI 107 screen, a notification of the message on a wearable device 140 display with a direction for the occupant to actuate an input mechanism. The input mechanism may include, e.g., a button on the wearable device 140, a switch, a voice command, and/or a touchscreen prompt on the wearable device 140 display, etc. The user device 150 may optionally send the message to the server 125 to indicate that the message is being provided to the occupant to resolve. The process 200 may optionally skip the block 230, and, after the block 225, proceed to a block 240 where the computing device 105 displays the message and information on how to resolve the message on the vehicle HMI 107. Alternatively, the computing device 105 may provide the instruction to the wearable device 140 to display the notification of the message.

Next, in a block 235, the user device 150 determines whether the input mechanism has been actuated. The device 150 and/or computer 105 is programmed to provide an instruction upon actuation to the user device 150 to provide more information on a vehicle human machine interface (HMI) 107 about the message and the system relating to the message. If the input mechanism has been actuated, the process 200 continues in the block 240. Otherwise, the process 200 returns to the block 210 to collect more messages. Alternatively, the action mechanism may provide the instruction to display information to the computing device 105.

In the block 240, the user device 150 provides an instruction to the computing device 105 to display the message and information on how to resolve the message, i.e., receive input or meet some other condition, e.g., allowing an amount of time to elapse, whereupon the message is no longer displayed. The information may include further information about the system that generated the message that requires the occupant's immediate attention. For example, if the message is for a phone call on the user device 150, the vehicle HMI 107 may display the phone number and identifying information of the caller. In another example, if the message is for low tire pressure, the computing device 105 may display tire pressure for each tire and a location of a nearby repair shop to refill the tires. Further examples include, e.g., if the vehicle 101 notices a strong change in driving behavior, such as a hard brake, quick acceleration, rash driving, etc., the message could tell the occupant to be mindful of their driving, or if an engine light is activated, depending on the reason for activation and the seriousness of the issue, the message may indicate to pull over immediately or to continue driving but attend to the issue soon. Upon resolution of the message, e.g., receiving user input acknowledge the message, the computing device 105 and/or the user device 150 may send information to the server 125 to update the message as resolved. The resolved messages may be used to predict future messages and/or provide information to the occupant to take preventative action regarding vehicle 101 systems. In addition to the vehicle HMI 107, the computing device 105 may display the message and the information on how to resolve the message on the wearable device 140 and/or the user device 150.

Next, in a block 245, the user device 150 determines whether to continue with the next message. If so, the process 200 returns to the block 210 to collect more message and determine the next highest ranked message. Otherwise, the process 200 ends. This step may be omitted, and the process 200 may automatically return to the block 210 to collect more messages and display information on the next highest ranked message.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

Computing devices 105 generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 200, one or more of the steps could be omitted, or the steps could be executed in a different order than shown in FIG. 2. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1.-20. (canceled)

21. A system, comprising a computer including a processor and a memory, the memory storing instructions executable by the computer to:
prioritize a plurality of messages received within a predetermined period of time, each of the messages including data relating to one of a plurality of vehicle systems; and
provide an output in a wearable device according to a highest priority message.

22. The system of claim 21, wherein the instructions further include instructions to request user input concerning a displayed message.

23. The system of claim 222, wherein is the user input requested is at least one of a button, a voice command, and a touchscreen prompt.

24. The system of claim 21, wherein the instructions further include instructions to display a message with a next highest rank after user input is received in response to a message with resolved higher rank.

25. The system of claim 21, wherein the prioritization is based on a diagnostic message having a highest priority, a phone call message having a lower priority than the diagnostic message, and entertainment messages having a priority lower than the phone call message and the diagnostic message.

26. The system of claim 21, wherein the instructions further include instructions to prioritize the messages in a handheld user device.

27. The system of claim 21, wherein the instructions further include instructions to display the message on the wearable device with a request for user input.

28. The system of claim 21, wherein the output is at least one of a haptic output and an audio output.

29. The system of claim 21, wherein the message is received from a remote server.

30. The system of claim 229, wherein the instructions further include instructions to generate and send a new message to the remote server indicating that a received message is resolved.

31. A method, comprising:
prioritizing a plurality of messages received within a predetermined period of time, each of the messages including data relating to one of a plurality of vehicle systems; and
providing an output in a wearable device according to a highest priority message.

32. The method of claim 31, further comprising requesting user input concerning a displayed message.

33. The method of claim 31, further comprising displaying a message with a next highest rank after user input is received in response to a message with resolved higher rank.

34. The method of claim 31, wherein the prioritization is based on a diagnostic message having a highest priority, a phone call message having a lower priority than the diagnostic message, and entertainment messages having a priority lower than the phone call message and the diagnostic message.

35. The method of claim 31, wherein the output is at least one of a haptic output and an audio output.

36. A system, comprising:
a wearable device;
means for prioritizing a plurality of messages received within a predetermined period of time, each of the messages including data relating to one of a plurality of vehicle systems; and
means for providing an output in the wearable device according to a highest priority message.

37. The system of claim 36, further comprising means for requesting user input concerning a displayed message.

38. The system of claim 36, further comprising means for displaying a message with a next highest rank after user input is received in response to a message with resolved higher rank.

39. The system of claim 36, wherein the prioritization is based on a diagnostic message having a highest priority, a phone call message having a lower priority than the diagnostic message, and entertainment messages having a priority lower than the phone call message and the diagnostic message.

40. The system of claim 36, wherein the output is at least one of a haptic output and an audio output.
